(19) United States
(12) Patent Application Publication
(10) Pub. No.: US 2012/0284202 A1
(43) Pub. Date: Nov. 8, 2012

(54) SYSTEMS AND METHODS FOR DETERMINING SUITABILITY OF REAL ESTATE

(75) Inventor: Timothy James Dalby, Edmonton (CA)

(73) Assignee: FIND A HOME CORP., Edmonton (CA)

(21) Appl. No.: 13/103,019

(22) Filed: May 6, 2011

(51) Int. Cl. G06Q 50/00

(52) U.S. Cl. 705/313

(57) ABSTRACT

Systems and methods relating to the determination of notable locations around a specific address. The notable locations within a predetermined radius of the specific address are mapped and noted. Each notable location within that radius contributes (either increases or decreases) a score for a particular category. Each category relates to a particular concern that might relate to a specific demographic or segment of the population. The score for each category is then presented to a user. The user may also enter a ranking of the various categories and specific addresses whose scores are in line with the user's ranking may also be presented to the user. The notable locations around a specific address may be found in a database supplied by the municipality or any other source or may be derived from a digital map of the area.

### TECHNICAL FIELD

The present invention relates to methods and systems which may be used for real-estate transactions. More specifically, the present invention relates to systems and methods for determining what institutions and notable locations are around a specific address.

### BACKGROUND OF THE INVENTION

The field of real estate purchasing or renting is a fickle and fast moving one. Some real estate buyers are looking to buy real estate for investment purposes, others are looking for commercial space, while some are looking for a family home. Similarly, those who are seeking to rent real estate may simply be looking for a temporary home (e.g. students in university or college) or for a more permanent home where they can put down roots until they can afford to buy their own home while others are looking for office space to rent.

All these potential purchasers or renters will have their own different priorities when it comes to what they are looking for in a property. Family oriented buyers would be looking for schools, libraries, and other family friendly locations. Students would be looking for close access to the university or college they are attending or, failing that, close access to public transportation hubs or to public transportation routes. Similarly, senior citizens may be looking for access to health centers or to police stations. Commercial renters or buyers may be looking for easy access to public transportation for their workers or ready access to potential customers. Notable locations, locations that provide access to services or locations which would be of use to residents of a neighborhood (e.g. bus stops, schools, etc.) would, preferably by located close to a property that is being considered by a potential buyer or renter.

Currently, there are no easily available means to determine what notable locations are near a given property. A potential purchaser or renter may, of course, manually map out notable locations nearby but, as can be imagined, this can be quite tedious if multiple properties are being considered. As well, manually mapping out the area may only involve notable locations that are important to a specific purchaser/renter and their needs.

Real estate boards and real estate agents can also provide similar data to potential purchasers/renters. However, their data may not reflect all of the notable locations surrounding the property. Also, the data may not include how far these notable locations are from the property. Finally, these real estate boards and agents do not provide a comparison between available properties that a ranking provides. A potential purchaser/renter would still need to do quite a lot of research into the matter to be properly informed about the area.

There is therefore a need for methods and systems which mitigate if not overcome the prior art.

### SUMMARY OF INVENTION

The present invention provides systems and methods relating to the determination of notable locations around a specific address. The notable locations within a predetermined radius of the specific address are mapped and noted. Each notable location within that radius contributes (either increases or decreases) a score for a particular category. Each category relates to a particular concern that might relate to a specific demographic or segment of the population. The score for each category is then presented to a user. The user may also enter a ranking of the various categories and specific addresses whose scores are in line with the user's ranking may also be presented to the user. The notable locations around a specific address may be found in a database supplied by the municipality or any other source or may be derived from a digital map of the area.

In a first aspect, the present invention provides a method for determining a suitability of a real estate property for a specific user, the method comprising:
a) receiving an address for said real estate property;
b) determining which notable locations are within a predetermined radius of said address;
c) for each notable location within said radius, adding to a score to at least one of a plurality of predetermined categories; and
d) providing said score for each of the plurality of categories to said user.

In a second aspect, the present invention provides a method for ranking real estate property based on a plurality of predetermined categories, the method comprising:
a) determining a location of said real estate property;
b) determining notable locations within a predetermined radius of said real estate property;
c) for each notable location within said predetermined radius of said real estate property, adding a value to at least one category aggregate score, each category aggregate score being related to a predetermined category;

wherein
each predetermined category relates to a type of service available to a user of said real estate property.

### BRIEF DESCRIPTION OF THE DRAWINGS

The drawings show features and advantages will become more apparent from a detailed consideration of the invention when taken in conjunction with the drawings in which:

FIG. 1 is a block diagram of a distributed computing system environment in which the invention may be practiced;

FIG. 2 is a screenshot of one implementation of the invention; and

FIG. 3 is a flowchart of a method according to one aspect of the invention.

### DETAILED DESCRIPTION OF THE INVENTION

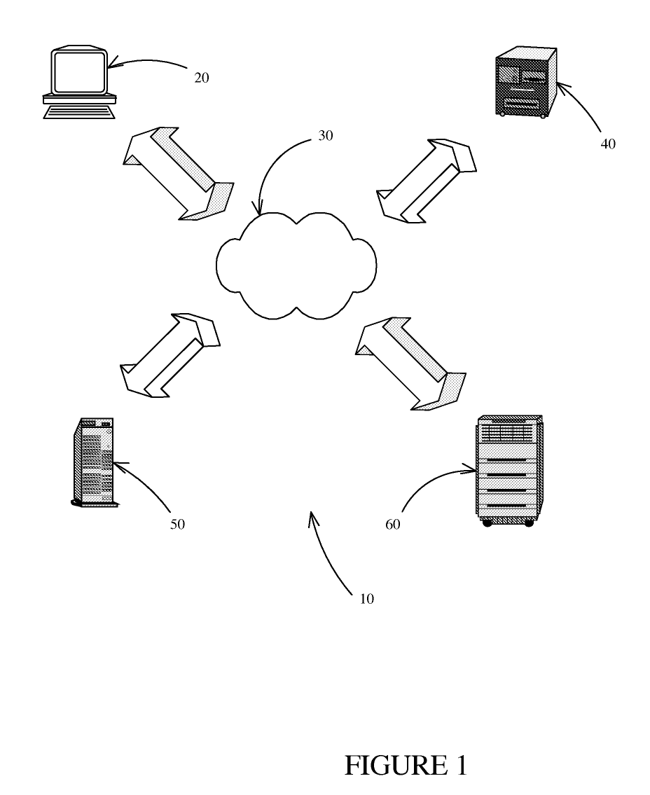

As noted above, users or potential purchasers/renters need data regarding notable locations around a specific address. The present invention may be practiced on a system as illustrated in FIG. 1. It should be noted that while the examples provided below seemingly relate to residential properties, similar concerns also exist for potential purchasers or renters of commercial property. As such, the present invention is not limited to residential locations but also to commercial locations and properties as well.

FIG. 1 illustrates a distributed computing system environment 10 on which the invention may be practiced. A user computer 20 is coupled to a network 30. An application server 40 is also coupled to the network 30 and, through the network 30, communicates with the user computer 20. A map data server 50 may also be coupled to the network 30 (which may be the Internet) as well as a map server 60. The map data server 50 would have map data regarding at least one region in a municipality of interest to the user using user computer 20. The map server 50 would have detailed maps for the same municipality. The application server 40 communicates with either the map data server 50 or the map server 60 or both servers to retrieve maps from the map server 60 or map data from the map data server 50.

A user wanting information regarding notable locations (locations that provide access to services or locations which would be of use to residents of a neighborhood) would enter the address of a real property of interest into the user computer 20. The user computer 20 would then communicate the address to the application server 40. If the application server 40 does not have the data needed, the data would need to be retrieved from the map data server 60 or, alternatively, the map for the area would be retrieved from map server 50. If the map is retrieved from map server 50, the map would then be analyzed for the requested data. Once the data has been retrieved from the map data server 60 or derived from the map from the map server 50, the data can then be analyzed by the application server 40. The result of the analysis is then communicated to the user computer 20 and, ultimately, to the user.

Each notable location within a specific radius of an address of interest to the user is categorized (each notable location relates to one or more predetermined categories) and, depending on what the notable location is as well as the distance to the address, adds or subtracts to a score for its category or categories. The score for each of the various categories will provide an indication as to the suitability (or unsuitability) of the real estate property at the address for a possible particular concern of a user. Each category may be seen as relating to a type of service available to a user or resident of the address or real estate property of interest. As an example, one possible category is health care. The notable locations under this category would be health care facilities or locations which would be of assistance to health care providers (e.g. ambulance capable facilities, first aid capable locations or services such as fire stations). The score (a category aggregate score or an aggregate of all the scores generated for the category by relevant notable locations) can thus be seen as an indication of convenience or how convenient it is for users or residents of the address or real property of interest to access the service from the notable location.

The data needed by the application server may take the form of the notable locations in the area of the address as well as the location (e.g. map coordinates) of these notable locations. From this data, the application server can determine which notable locations are within a specified radius of the address. The application server, if provided with map coordinates of the notable locations and the address can determine the distance between each notable location and the address. This distance is calculated for each notable location and the distance is taken into consideration when determining how much to add or subtract to a score for a particular category. If the GPS (Global Positioning System) coordinates for each notable location is given in lieu of the map coordinates, the distance between each notable location and the address can also be computed using well-known methods.

If the map data server is unavailable or if the map data (e.g. the coordinates of the notable locations) are unavailable, the application server may retrieve the map of the area from the map server. The application server can then analyze the retrieved map for the map data required. As an example, if the map retrieved has sufficient information about notable locations (e.g. each type of notable location is represented on the map by a different representative icon on the map), the application server can “parse” the map to find the coordinates for each notable location. This may, of course, involve applying a predetermined coordinate system to the map and using this coordinate system to determine distances between the address on the map and the notable locations surrounding the address. It should be noted that the distances calculated may be unitless if these are being determined based on map coordinates. Alternatively, if the scale of the map being used is known, the distances can be determined in the more acceptable units such as kilometers or miles.

Regarding the various categories, these may be predetermined by the operators of the application server. The categories may include:

Family Friendliness—the category would relate to notable locations which provide services relevant to families and may include notable locations such as:

libraries, groceries, elementary schools, high schools, recreational parks, green space (parks with greenery), hospitals, clinics, dental clinics, family oriented restaurants, playground parks, community centers, police stations, fire stations, clinics, pubs, jails, campgrounds, churches (or other places or centers of worship), golf courses, recreation centers, bicycle trails, mini-storage facilities, lakes, malls or shopping centers

Health Care—the category would include notable locations which may be of assistance to those concerned about their health and access to health care (e.g. the elderly or those with pre-existing critical medical conditions) may include notable locations such as:

hospitals, clinics, dental clinics, doctors' clinics, ambulance capable facilities, fire stations, police stations, drug stores, chiropractic treatment centers, physiotherapy clinics or centers, massage therapy centers

Transportation—the category includes notable locations which may be of assistance to those concerned about access to transportation services and facilities and may include notable locations such as:

bus stops, subway stations, train stations, bus stations, taxi stations, highway on-ramps, highway off-ramps, light rail transit (LRT) stations, public parking

Young Adult Amenities—the category may include notable locations such as:

fast-food restaurants, discotheques, clubs, universities, colleges, groceries, libraries, pubs, liquor stores, corner stores, shopping malls, fitness centers, hospitals, clinics,

Safety—the category may include notable locations such as:

police stations, jails, fire stations, hospitals, halfway houses, charitable missions, homeless shelters, movie theaters, pubs,

Each category may have a different radius associated with it. As such, instead of having a single radius about the address or real estate property around which notable locations are to be determined, each category would have a different radius around which that category's relevant notable locations are to be determined. In one example, the transportation category may have a radius of 0.5 km associated with it as bus stops, bus stations, train stations, etc. that are within walking distance of the address may be of importance to the user. Conversely, the health care category may have a radius of 2 km associated with it as health care providers and first responders have vehicles and a 2 km radius would ensure a prompt response should a health emergency ever arise at the address.

The categories listed above are not exhaustive and other categories may also be used. As well, the categories listed above may be broken down into sub-categories that may be used in place of those listed. In one example, the safety category may be broken down into fire response and police response categories. The fire response category takes into account not simply how many fire stations are around the address but also how far they are and, concomitantly, how fast their response times would be. The police response category takes into account the police stations near the address and how fast their response would be. For these response sub-categories, the score they contribute may be based on how far they are from the address of interest. Alternatively, the score for these response sub-categories may only be based on how far from the address is the closest police or fire station.

It should further be noted that the notable locations noted above may each generate positive or negative scores for each category, with each category score being an aggregate of the scores contributed by each notable location. As an example, if an address had, within the predetermined radius, 2 fire stations, 2 hospitals, a homeless shelter, a shopping mall, jail, 3 pubs, and a high school, the aggregate score would be different for each category. For family friendliness, the fire stations, hospitals, and high schools would all contribute positive scores while the jail, homeless shelter, and pubs would all contribute negative scores to the overall aggregate. For the safety category, the same area would have negative scores added to the aggregate safety score for the jail and the homeless shelter but would have positive scores added to the aggregate for the fire stations and the hospitals. Similarly, for the young adult amenities category, the pubs would add a positive score to the category aggregate. As can be seen, a notable location, depending on what the notable location is, can add or subtract to a category aggregate score. For safety and family friendliness, a pub may be seen as a negative addition while the same pub may be a positive addition to the aggregate score for the young adult amenities category.

It should be noted that other categories are possible and should not be limited to only those noted above. Other categories are, of course, possible. Categories may differ by implementation of the invention as other categories which illustrate the concerns, needs, or interests of various segments of the population may be formulated. As an example, a fitness and recreation category may be implemented to cater to potential real estate purchasers or renters who are looking for properties that are in close proximity to health clubs, gyms, wellness centers, vitamin shops, parks, swimming pools, bicycle paths and bicycle parks, skateboard parks, sports grounds, recreation centers, and other centers of recreation and physical fitness.

The scoring for each notable location within a given radius of the address of interest may be implemented in various ways. As an example, each notable location within the given radius may be given a predetermined equal score (positive or negative) for a given category. The overall aggregate category score would simply be the aggregate of all these individual scores. Thus, if there are 3 positive notable locations within the predetermined radius of an address, and each notable location was given a score of 5, then the aggregate category score would be 15. If there are 2 negative notable locations within the radius for the same address, then the aggregate category score would be 15 less the 10 for the negative locations, i.e. an aggregate category score of 5.

A more complicated but possibly more useful scoring system would weigh each notable location's contribution to the category aggregate score depending on how far the notable location is from the address. Each positive notable location would have a higher weighting the closer the location is to the address. Each negative notable location (a notable location which detracts from the category, e.g. a jail or homeless shelter in the safety category) would have a higher negative weighting the closer it is to the address. Of course, this scheme would require that the distance between the notable location and the address be known or calculable.

One possible option for the scoring would be to cap the number of a specific type of notable location. As an example, if a particular area had a lot of parks in the vicinity, not limiting the number of parks in the relevant notable locations can skew the category aggregate score for categories which include parks as a notable location. This variant for the scoring system would have different types of notable locations and only a certain number of notable locations would count towards the category aggregate score. As another example, for a certain address, only 3 police stations would be allowed to contribute to the various category aggregate scores and only 5 fast food restaurants would add to the relevant category aggregate scores.

The scoring for each notable location may, of course, be a hybrid of the above alternatives. For locations where the distances are known (e.g. through GPS coordinates, detailed map references, or database entries), the weighted scoring system may be used. For locations where data may be sparse, the fixed scoring scheme may be used.

Once the aggregate category scores have been calculated, these are then sent to the user computer and then presented to the user. The scores may start at a base score before the additions (or subtractions) due to the notable locations are taken into account. This would provide a baseline score for each category.

The presentation of the aggregate category scores may be adjusted so that each address is ranked by its aggregate category scores. Thus, an address may have its category scores arranged so that the highest scoring category is shown first. If a user wishes to check multiple addresses, each address can have its category scores calculated and the addresses can be presented to the user by order of which category score is highest. As an example, if the user wishes to see how multiple addresses compare to each other on the family friendliness category, the category scores for each address are calculated or determined and the different addresses are ranked according to their family friendliness category aggregate score.

In one implementation of the invention, the concept of ranking can be used to recommend addresses to a user based on the user's desired categories. The user can rank the available categories by his/her priorities. This ranking is then transmitted to the application server. The application server then retrieves the addresses of available real estate properties, determines their category aggregate scores, and then ranks these available addresses in accordance with their category scores and the user's ranking of the categories. As an example, if the user ranked safety as their highest priority, then the addresses with the highest safety category aggregate scores are at the top of the list of recommended properties. Then, if the user ranked family friendliness as their second category by priority, the addresses with the highest family friendliness category aggregate scores are next in the list presented to the user.

To help determine which area of a city or municipality a user may wish to search in, one aspect of the invention involves using the invention to determine a region's score with respect to the various categories. For a region in a city (e.g. a well-defined neighbourhood in the city), the center of the region is determined and then the notable locations within the region or area are found. These notable locations within the region are then used to score that region in the various categories. Clearly, for such an implementation, the distances between notable locations and a specific address need not be calculated. Based on the number and type of notable locations in a specific region, that region's score can be determined for the various categories. Once a region's category scores have been determined, these are then compared to a user's ranking of the various categories. A region whose scores most closely match that user's ranking of the categories can then be recommended to the user.

It should be noted that the above can be used for different regions in a municipality. The various regions can have their category scores determined and the regions whose category scores are closest to the ranking of a user's priority categories are then recommended to the user. As an example, it can be assumed that Region A has category scores as follows:

Safety—10

Family Friendliness—8

Young Adult Amenities—7

Health Care—5

Transportation—3

Region B has the following category scores

Family Friendliness—9

Health Care—7

Transportation—6

Safety—5

Young Adult Amenities—3

Region C has the following category scores:

Family Friendliness—8

Safety—7

Transportation—5

Young Adult Amenities—3

Health Care—2

A user who ranked the safety category as their main priority would, using the data above, have Region A recommended first to them followed by Region C. This is because Region A has the highest safety category score while Region C has the second highest safety category score. A user who ranked the health care category as their main priority would have Region B recommended first then Region A as Region B has the highest health care category score.

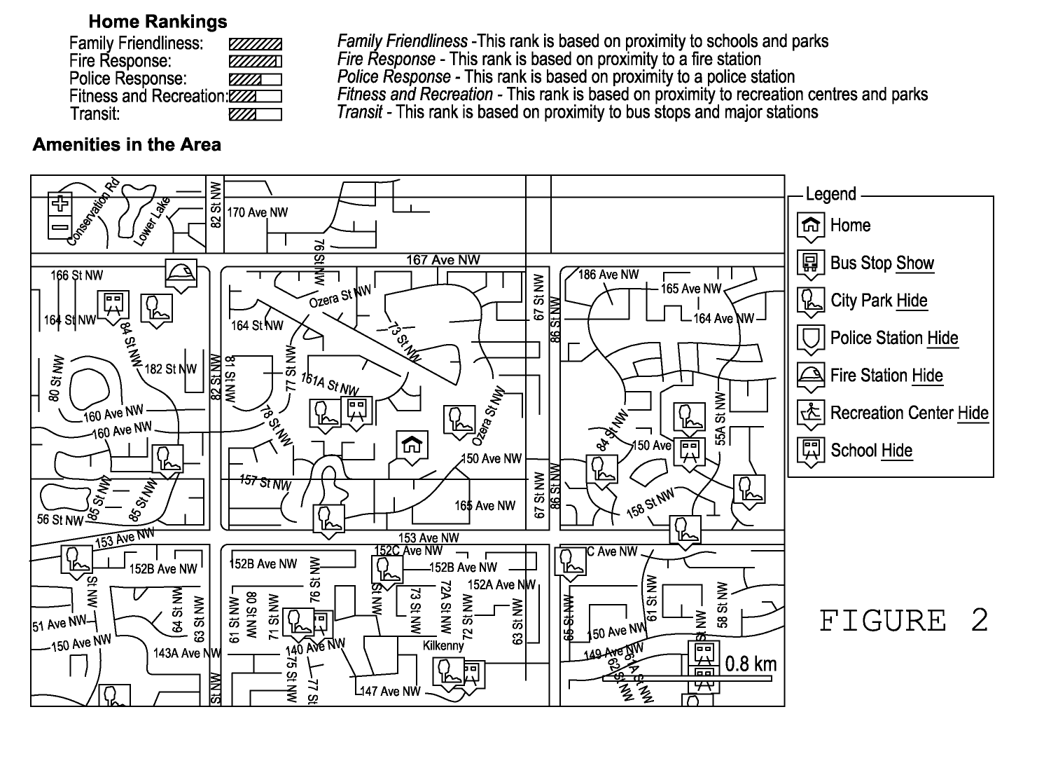

Referring to FIG. 2, a screenshot of one implementation of the invention is presented. As can be seen from the Figure, the address is shown in the middle of the map. The notable locations are illustrated on the map and their categories are shown at the top left corner of the Figure. The category scores are shown as bars instead of a numerical figure for ease of understanding. It should be noted that the notable locations used to determine the category aggregate scores for the Figures are a small subset of what could be used. As an example, the family friendliness category for the Figure only takes into account schools and parks. The Figure also shows a legend box at the right so a user can see which notable locations are around the address of interest.

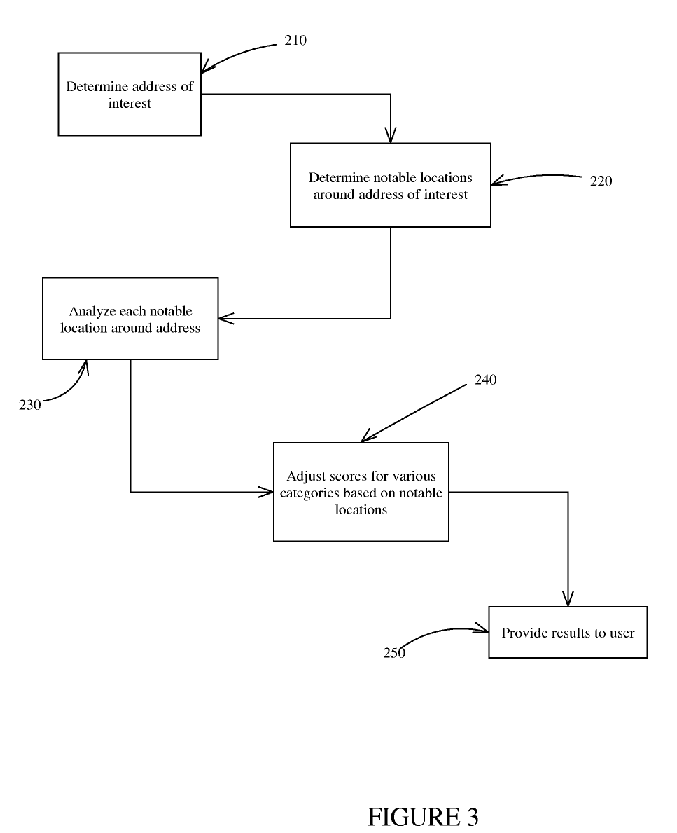

Referring to FIG. 3, a flowchart of a method according to one aspect of the invention is illustrated. The method begins at step 210, that of determining the address of interest. This can be done by receiving user input as to the address, setting a center of a neighbourhood or region as the address, or any number of well-known ways to find a specific address of interest. Step 220 then determines what notable locations are around the address of interest. This may be done by analyzing a detailed map of the area (i.e. extracting information from the map, determining distances between the address of interest and the various notable locations, etc.) or by retrieving information from a database. The notable locations are then analyzed (step 230) to determine which categories they pertain to and whether the notable locations are to add or subtract to scores for the various categories. This may entail (as noted above) whether the notable locations are within a specific distance of the address of interest, whether there is a cap on the number of specific types of notable locations, and whether each notable location is within such a cap. Step 240 then adjusts the various category aggregated scores based on the various notable locations. The scores are then presented to the user in step 250.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product). Other embodiments of the invention may also reside as a software program on portable devices such as mobile handsets, tablet computers, or on any other data processing device with all or part of the logic code residing on the data processing device. The data processing device, mobile computing device, or whatever device which is executing or storing the logic code may or may not be in communication with application servers over a communications network, whether it be a cellular communications network, a primarily digital communication network, or a distributed network such as the Internet.

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for determining a suitability of a real estate property for a specific user, the method comprising:
a) receiving an address for said real estate property;
b) determining which notable locations are within a predetermined radius of said address;
c) for each notable location within said radius, adding to a score to at least one of a plurality of predetermined categories; and
d) providing said score for each of the plurality of categories to said user.

2. A method according to claim 1 wherein said notable locations includes at least one of the following:
bus stations;
centers of worship;
religious centers;
bus stops;
train stations;
subway stations;
restaurants;
schools;
libraries;
community centers;
fitness centers;
universities;
colleges;
grocery stores;
shops;
shopping malls;
law enforcement facilities;
police stations;
highway access onramps;
highway access offramps;
hospitals;
clinics;
jails;
homeless shelters;
drug stores.

3. A method according to claim 1 wherein each type of notable location adds a different amount to said score.

4. A method according to claim 1 wherein said plurality of predetermined categories includes at least one of the following:
family friendliness;
public transport;
health care;
safety; or
young adult amenities.

5. A method according to claim 1 wherein step b) comprises:
retrieving data for each notable location from a database;
for each notable location, executing the following steps:
determining a distance from said address to said notable location;
determining if said notable location is within said predetermined radius.

6. A method according to claim 1 wherein step b) comprises:
retrieving a map of an area including said address;
determining notable locations from said map;
for each notable location from said map, executing the following steps:
determining a distance from said address to said notable location;
determining if said notable location is within said predetermined radius.

7. A method according to claim 1 wherein said method includes the step of:
receiving a ranking input from said user, said ranking input being a ranking of said predetermined categories by said user.

8. A method according to claim 7 wherein said method is executed for a plurality of addresses, said plurality of addresses being in different areas of a municipality.

9. A method according to claim 8 wherein said plurality of addresses are ranked based on scores for each address for each of said categories such that said addresses are ranked in a ranking similar to said ranking input from said user.

10. A method according to claim 1 wherein said method is executed for a plurality of addresses, said plurality of addresses being in different areas of a municipality.

11. A method according to claim 10 wherein said plurality of addresses are ranked based on scores for each address for each of said categories.

12. A method for ranking real estate property based on a plurality of predetermined categories, the method comprising:
a) determining a location of said real estate property;
b) determining notable locations within a predetermined radius of said real estate property;
c) for each notable location within said predetermined radius of said real estate property, adding a value to at least one category aggregate score, each category aggregate score being related to a predetermined category;
wherein
each predetermined category relates to a type of service available to a user of said real estate property.

13. A method according to claim 12 wherein each category aggregate score is an indication of convenience for said user of said real property to access said type of service from said real estate property.

14. A method according to claim 12 wherein said location of said real estate is a center of a region of a municipality.

15. A method according to claim 12 wherein each predetermined category also relates to notable locations within said predetermined radius which affect safety considerations for said user of said real estate property.
